(19) United States
(12) Patent Application Publication
(10) Pub. No.: US 2024/0343602 A1
(43) Pub. Date: Oct. 17, 2024

(54) ALUMINUM-DOPED NEEDLE-LIKE COBALTOSIC OXIDE AND PREPARATION METHOD THEREFOR

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Aixia Li, Foshan, Guangdong (CN); Yinghao Xie, Foshan, Guangdong (CN); Bo Li, Foshan, Guangdong (CN); Changdong Li, Foshan, Guangdong (CN)

(21) Appl. No.: 18/682,147

(22) PCT Filed: Dec. 1, 2022
(86) PCT No.: PCT/CN2022/135944

§ 371 Date: Feb. 8, 2024

(30) Foreign Application Priority Data
Feb. 22, 2022 (CN) 202210163654.0

(51) Int. Cl. C01G 51/04; H01M 10/54

(52) U.S. Cl. CPC C01G 51/04; C01P 2002/54; C01P 2004/03; C01P 2004/04; C01P 2004/10; C01P 2006/12; H01M 10/54

(57) ABSTRACT

The present application belongs to the technical field of battery materials, and discloses an aluminum-doped needle-like cobaltosic oxide and a preparation method therefor. The preparation method comprises the following steps: mixing a waste battery powder and an amino acid, adjusting the pH until an alkaline state is reached, and subjecting same to solid-liquid separation to obtain an aluminum-removed battery powder and a first filtrate; adding an acid to the aluminum-removed battery powder, mixing same, and subjecting same to solid-liquid separation to obtain a cobalt-containing acid solution and a copper-containing slag; adding, in a dropwise manner, a templating agent to the cobalt-containing acid solution, then adding an alkali to adjust the pH, centrifuging same, and subjecting same to a heat treatment to obtain an aluminum-doped needle-like cobaltosic oxide.

### FIELD

The present disclosure belongs to the technical field of lithium-ion batteries, specifically relates to aluminium-doped needlelike tricobalt tetroxide and a preparation method therefor.

### BACKGROUND

Existing strategies for recycling waste lithium-ion batteries mainly include hydrometallurgical recovery and pyrometallurgical recovery. Among them, the hydrometallurgical recovery is used more extensively as being suitable for industrialization, owing to its high recovery rate, and normal temperature reaction. Current hydrometallurgical process comprises pretreatment, leaching and regeneration. Generally speaking, the key of the pretreatment as the ground of the above process, is to effectively separate the aluminum foil from waste materials and waste electrode plates.

Commonly used separation method can be classified into organic solvent dissolution method, pyrolysis, alkali leaching and acid leaching. The organic solvent dissolution method can dissolve polyvinylidene fluoride (PVDF) in short time, but it has disadvantages of organic toxicity, volatility and high price. When this method is used to dissolve aluminum foils to separate a cathode material, it tends to damage the device. The pyrolysis method can be used for PVDF decomposition, but it has high energy consumption, low cost and harmful gas release. Using the alkali leaching method to dissolve aluminum, generally has problems of incomplete removal of aluminum, loss of cobalt, cumbersome recovery steps, and residues in the solution. Using inorganic acid leaching to dissolve aluminum, has a problem that it only can selectively dissolve few substances, and cathode active materials and aluminum will both be dissolved, and thus additional recovery of aluminum is required. In addition, in hydrometallurgical recovery, the recovery of cobalt requires a long process including precipitation for removing impurities, extraction, back-extraction, and crystallization, etc., which uses many kinds of chemical reagents, causing very cumbersome treatment of the solution subsequently. Therefore, it is significant to develop a clean and efficient recycling method for recovering aluminum and preparing it into doped tricobalt tetroxide.

### SUMMARY

The following is a summary of subject matters described in detail herein. This summary is not intended to limit the scope of protection of the claims.

The present disclosure aims to solve at least one of the above-mentioned technical problems in prior art. For this purpose, the present disclosure provides aluminium-doped needlelike tricobalt tetroxide and a preparation method therefor. According to this preparation method, aluminium can be effectively recovered from waste batteries, and tricobalt tetroxide with better needlelike morphology is produced, by performing thermal treatment after adjusting pH under the condition of the addition of a template agent so as to cover cobalt with the carbon or aluminum generated from the thermal treatment and to mitigate the further agglomeration and the coupling of the template agent with cobalt ions during packaging.

In order to realize the above objective, the present disclosure adopts the following technical solution.

A method for preparing aluminium-doped needlelike tricobalt tetroxide comprises the following steps:
(1) mixing waste battery powder with an amino acid solution, adjusting pH to alkalinity, and performing solid-liquid separation, to obtain aluminum-removed battery powder and a first filtrate;
(2) mixing the aluminum-removed battery powder with an acid solution, and performing solid-liquid separation, to obtain a cobalt-containing acid solution and a copper-containing slag; and
(3) adding a template agent into the cobalt-containing acid solution dropwise, adjusting pH with an alkali, performing centrifugation and thermal treatment, to obtain the aluminium-doped needlelike tricobalt tetroxide.

Preferably, in step (1), the waste battery powder is prepared by disassembling a waste lithium cobaltate traction battery pack into cells, discharging the cells, performing thermal decomposition on the cells in a rotary kiln, cooling, shredding, and screening.

Further preferably, the discharge of the cells consists of resistance-discharging the cells on a metal frame until single cell voltage <2.0 V.

Further preferably, the thermal decomposition in the rotary kiln is carried out at a temperature of 400-800° C. for a duration of 4-24 h under an atmosphere of nitrogen gas.

Preferably, in step (1), the amino acid is aminoacetic acid; and the solid-liquid ratio of the waste battery powder to the amino acid solution is 10-60 g/L.

Further preferably, the amino acid solution has a concentration of 5 wt %-20 wt %.

Preferably, in steps (1) and (3), the alkali used in the pH adjustment is one of lithium hydroxide, sodium hydroxide, and potassium hydroxide.

Preferably, in step (1), the adjusting pH to alkalinity means adjusting pH to 9.5-12.

Preferably, in step (2), the acid solution has a temperature <10° C.

Preferably, in step (2), the acid solution is sulfuric acid.

Further preferably, the sulfuric acid has a concentration of 0.01-0.05 mol/L.

Preferably, in step (2), the solid-liquid ratio of the aluminum-removed battery powder to the acid solution is 10-150 g/L.

Preferably, in step (3), the method further comprises diluting the cobalt-containing acid solution with water, to obtain a cobalt-containing acid solution having a cobalt concentration of 0.01-0.05 mol/L.

Preferably, in step (3), the template agent is added into the cobalt-containing acid solution dropwise in a molar quantity 1-5 times that of cobalt in the cobalt-containing acid solution.

Further preferably, the method comprises adding the first filtrate obtained in step (1) at an amount of 0.001-0.01 of the volume of the cobalt-containing acid solution during the addition of the template agent dropwise into the cobalt-containing acid solution.

Preferably, in step (3), the template agent is one of aminosalicylic acid and hydroxyl-containing benzoic acid.

Preferably, the Co(OH)(C₇H₆NO₃) is synthesized by:

Co²⁺+C₇H₇NO₃+LiOH+Al(OOC—CH₂—NH₂)₃+Al(OOC—CH₂—NH₂)₃→Co(OH)(C₇H₆NO₃)Al(OOC—CH₂—NH₂)₃+H₂O+Li⁺.

Through dehydrogenation of carboxyl group, bonding of alkali after dilithiation with cobalt ions, Co(OH)(C₇H₆NO₃) is synthesized.

Preferably, in step (3), adjusting pH with an alkali means adjusting pH to 6.5-7.2.

Preferably, in step (3), the thermal treatment is carried out at a temperature of 550-750° C. for a duration of 1-6 h.

Preferably, in step (3), the thermal treatment is carried out under an atmosphere of air.

The thermal treatment is a process of decomposition of Co(OH)(C₇H₆NO₃), dehydration, deoxidation and decarbonization at high temperature.

Aluminium-doped needlelike tricobalt tetroxide is prepared through the following reaction equation:

HOOC—CH₂—NH₂+LiOH→Li—OOC—CH₂—NH₂+H₂O;

Al₂O₃+LiOH→LiAlO₂+H₂O:

2Al+2LiOH+2H₂O→2LiAlO₂+3H₂;

6HOOC—CH₂—NH₂+Al₂O₃→2Al(OOC—CH₂—NH₂)₃+3H₂O;

6HOOC—CH₂—NH₂+2Al→2Al(OOC—CH₂—NH₂)₃+3H₂;

LiAlO₂+4HOOC—CH₂—NH₂+H₂O→Al(OOC—CH₂—NH₂)₃+LiOOC—CH₂—NH₂+2H₂O;

Co²⁺+C₇H₇NO₃+LiOH+Al(OOC—CH₂—NH₂)₃→Co(OH)(C₇H₆NO₃)Al(OOC—CH₂—NH₂)₃+H₂O+Li⁺.

Provided is aluminium-doped needlelike tricobalt tetroxide prepared according to the above-mentioned method, which has a chemical formula of Co₃O₄@C/Al₂O₃ and a specific surface area of 3.4-3.6 m²/g.

The present disclosure further provides use of the above-mentioned aluminium-doped needlelike tricobalt tetroxide in the preparation of a catalyst, a cathode material or a capacitor.

Compared with the prior art, the present disclosure has the following beneficial effects.

According to the present disclosure, the aluminum in the waste battery is effectively recovered by using amino acids, and aluminium-doped needlelike tricobalt tetroxide with good morphology is obtained, by performing thermal treatment after adjusting pH under the condition of the addition of a template agent so as to cover cobalt with the carbon or aluminum generated from the thermal treatment and to mitigate the further agglomeration and the coupling of the template agent with cobalt ions during packaging.

According to the present disclosure, battery powder and amino acid (aminoacetic acid) are mixed and adjusted to alkaline pH. The proton at the carboxyl group of the amino acid (aminoacetic acid) is removed to form aminoacetic acid anions. On one hand, excess alkali reacts with aluminum oxide or aluminum to produce metaaluminate ions, preventing the formation of aluminum hydroxide precipitate at weak alkaline pH; the metaaluminate ions then react with aminoacetic acid to produce an Al(OOC—CH₂—NH₂)₃ chelate. On the other hand, aminoacetic acid reacts with aluminum oxide or aluminum to produce the Al(OOC—CH₂—NH₂)₃ chelate, effectively binding with Al³⁺ at weak acidity or basicity condition, so as to form a more stable product and prevent the formation of aluminum hydroxide precipitate at weak alkaline pH. Then, Co(OH)(C₇H₆NO₃)Al(OOC—CH₂—NH₂)₃ is synthesized by introducing cobalt ions and aminosalicylic acid as the template agent. After that, through the thermal treatment, Co(OH)(C₇H₆NO₃) is dehydrated, deoxygenated and decarbonized, carbon and aluminum produced from the carbonization of C₇H₆NO₃″ between Co(OH)⁺ layers and Al(OOC—CH₂—NH₂)₃ cover cobalt, which mitigates the further agglomeration and the nano-coupling during packaging, resulting in needlelike tricobalt tetroxide with good morphology.

### BRIEF DESCRIPTION OF DRAWINGS

FIG. 1 is an SEM image of the needlelike tricobalt tetroxide prepared in Example 1 of the present disclosure; and

FIG. 2 is a TEM image of the needlelike tricobalt tetroxide prepared in Example 1 of the present disclosure.

### DETAILED DESCRIPTION

The concept and the produced technical effects of the present disclosure will be clearly and completely described below with reference to the examples, so that the objective, characteristics and effects of the present disclosure can be fully understood. Apparently, the described examples are only a part of the examples of the present disclosure, rather than all of them. All the other examples, which is based on these examples of this disclosure, obtained by a person of ordinary skill in the art without creative labor should fall within the protection scope of the present invention.

### EXAMPLES

### Example 1

This example provided a method for preparing aluminium-doped needlelike tricobalt tetroxide comprising the following steps.

(1) A waste lithium cobaltate traction battery pack was disassembled into cells. The cells were resistance-discharged on a metal frame until single cell voltage <2.0 V, and then subjected to thermal decomposition in a rotary kiln at 400° C. for 6 h under nitrogen gas. The resulting product was cooled, shredded, and screened to remove the copper and aluminum foil as well as the separator, to obtain waste battery powder.

(2) The waste battery powder and 15.3 wt % of aminoacetic acid solution were mixed at an solid-liquid ratio of 15 g/L. The resulting solution was added with lithium hydroxide to adjust its pH to 10.3, and subjected to solid-liquid separation to obtain aluminum-removed battery powder and a first filtrate.

(3) The aluminum-removed battery powder was mixed with 0.0147 mol/L of sulfuric acid having a temperature <10° C. (at a solid-liquid ratio of 35 g/L), and subjected to solid-liquid separation, to obtain a cobalt-containing acid solution and a copper-containing slag.

(4) The cobalt content in the cobalt-containing acid solution was determined as 3.47 g/L. 150 mL of the cobalt-containing acid solution was diluted with water until its cobalt concentration was 0.029 g/L. Then, aminosalicylic acid was added dropwise to the cobalt-containing acid solution until the concentration was 0.057 mol/L, and also 0.3 mL of the first filtrate (having an aluminum content of 0.23 g/L) was added. The cobalt-containing acid solution was added with lithium hydroxide to adjust its pH to 6.8, stood for about 1.5 h, centrifuged, and washed to obtain a third solid Co(OH)(C₇H₆NO₃).

(5) The third solid Co(OH)(C₇H₆NO₃) was heated to 565° C. by a heating device, and kept for about 3 h, to obtain the aluminium-doped needlelike tricobalt tetroxide (Co₃O₄@C/Al₂O₃).

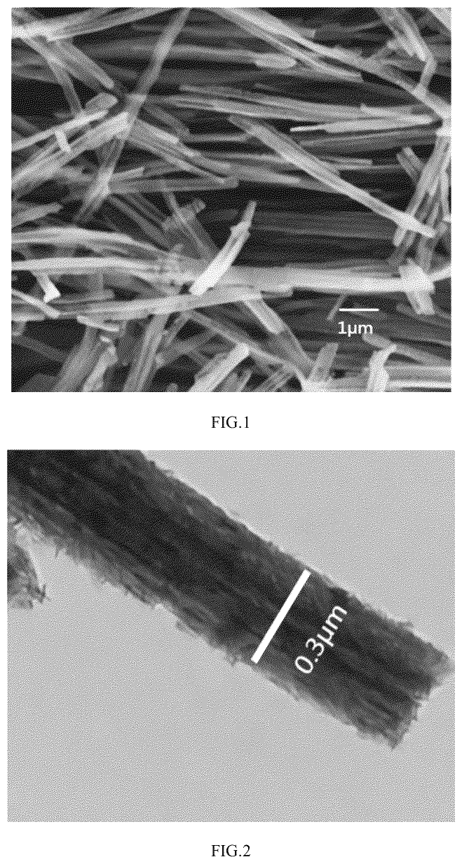

FIG. 1 was an SEM image of the needlelike tricobalt tetroxide prepared in Example 1 of the present disclosure. FIG. 2 was a TEM image of the needlelike tricobalt tetroxide prepared in Example 1 of the present disclosure. As can be seen from FIGS. 1-2, the prepared aluminium-doped needlelike tricobalt tetroxide (Co₃O₄@C/Al₂O₃) was long needle-like, had a diameter of about 0.3 μm and showed uniform morphology and good dispersion.

### Example 2

This example provided a method for preparing aluminium-doped needlelike tricobalt tetroxide comprising the following steps.

(1) A waste lithium cobaltate traction battery pack was disassembled into cells. The cells were resistance-discharged on a metal frame until single cell voltage <2.0 V, and then subjected to thermal decomposition in a rotary kiln at 400° C. for 6 h under nitrogen gas. The resulting product was cooled, shredded, and screened to remove the copper and aluminum foil as well as the separator, to obtain waste battery powder.

(2) The waste battery powder and 15.3 wt % of aminoacetic acid solution were mixed at a solid-liquid ratio of 18 g/L. The resulting solution was added with lithium hydroxide to adjust its pH to 10.1, and subjected to solid-liquid separation to obtain aluminum-removed battery powder and a first filtrate.

(3) The aluminum-removed battery powder was mixed with 0.0147 mol/L of sulfuric acid having a temperature <10° C. (at a solid-liquid ratio of 42 g/L), and subjected to solid-liquid separation, to obtain a cobalt-containing acid solution and a copper-containing slag.

(4) The cobalt content in the cobalt-containing acid solution was determined as 4.22 g/L, 150 mL of the cobalt-containing acid solution was diluted with water until its cobalt concentration was 0.034 g/L, Then, aminosalicylic acid was added dropwise to the cobalt-containing acid solution until the concentration was 0.063 mol/L, and 0.5 mL of the first filtrate (having an aluminum content of 0.25 g/L) was added. The cobalt-containing acid solution was added with lithium hydroxide to adjust its pH to 6.3, stood for about 1.5 h, centrifuged, and washed to obtain a third solid Co(OH)(C₇H₆NO₃).

(5) The third solid Co(OH)(C₇H₆NO₃) was heated to 615° C. by a heating device, and kept for about 3 h, to obtain the aluminium-doped needlelike tricobalt tetroxide (Co₃O₄@C/Al₂O₃).

### Example 3

This example provided a method for preparing aluminium-doped needlelike tricobalt tetroxide comprising the following steps.

(1) A waste lithium cobaltate traction battery pack was disassembled into cells. The cells were resistance-discharged on a metal frame until single cell voltage <2.0 V, and then subjected to thermal decomposition in a rotary kiln at 400° C. for 6 h under nitrogen gas. The resulting product was cooled, shredded, and screened to remove the copper and aluminum foil as well as the separator, to obtain waste battery powder.

(2) The waste battery powder and 12.5 wt % of aminoacetic acid solution were mixed at a solid-liquid ratio of 34 g/L. The resulting solution was added with lithium hydroxide to adjust its pH to 10.2, and subjected to solid-liquid separation to obtain aluminum-removed battery powder and a first filtrate.

(3) The aluminum-removed battery powder was mixed with 0.0147 mol/L of sulfuric acid having a temperature <10° C. (at a solid-liquid ratio of 66 g/L), and subjected to solid-liquid separation, to obtain a cobalt-containing acid solution and a copper-containing slag.

(4) The cobalt content in the cobalt-containing acid solution was determined as 6.49 g/L. 150 mL of the cobalt-containing acid solution was diluted with water until its cobalt concentration was 0.027 g/L. Then, aminosalicylic acid was added dropwise to the cobalt-containing acid solution until the concentration was 0.077 mol/L, and 0.5 mL of the first filtrate (having an aluminum content of 0.27 g/L) was added. The cobalt-containing acid solution was added with lithium hydroxide to adjust its pH to 7.0, stood for about 1.5 h, centrifuged, and washed to obtain a third solid Co(OH)(C₇H₆NO₃).

(5) The third solid Co(OH)(C₇H₆NO₃) was heated to 565° C. by a heating device, and kept for about 3 h, to obtain the aluminium-doped needlelike tricobalt tetroxide (Co₃O₄@C/Al₂O₃).

### Example 4

The method for preparing aluminium-doped needlelike tricobalt tetroxide of this example comprised the following steps.

(1) A waste lithium cobaltate traction battery pack was disassembled into cells. The cells were resistance-discharged on a metal frame until single cell voltage <2.0 V, and then subjected to thermal decomposition in a rotary kiln at 400° C. for 6 h under nitrogen gas. The resulting product was cooled, shredded, and screened to remove the copper and aluminum foil as well as the separator, to obtain waste battery powder.

(2) The waste battery powder and 12.5 wt % of aminoacetic acid solution were mixed at a solid-liquid ratio of 34 g/L. The resulting solution was added with lithium hydroxide to adjust its pH to 10.3, and subjected to solid-liquid separation to obtain aluminum-removed battery powder and a first filtrate.

(3) The aluminum-removed battery powder was mixed with 0.0147 mol/L of sulfuric acid having a temperature <10° C. (at a solid-liquid ratio of 66 g/L), and subjected to solid-liquid separation, to obtain a cobalt-containing acid solution and a copper-containing slag.

(4) The cobalt content in the cobalt-containing acid solution was determined as 6.49 g/L. 150 mL of the cobalt-containing acid solution was diluted with water until its cobalt concentration was 0.027 g/L. Then, aminosalicylic acid was added dropwise to the cobalt-containing acid solution until the concentration was 0.077 mol/L, and 0.5 mL of the first filtrate (having an aluminum content of 0.27 g/L) was added. The cobalt-containing acid solution was added with lithium hydroxide to adjust its pH to 7.0, stood for about 1.5 h, centrifuged, and washed to obtain a third solid Co(OH)(C₇H₆NO₃).

(5) The third solid Co(OH)(C₇H₆NO₃) was heated to 565° C. by a heating device, and kept for about 3 h. to obtain the aluminium-doped needlelike tricobalt tetroxide (Co₃O₄@C/Al₂O₃).

### Analysis of Example 1-4:

TABLE 1
The ratio of the aluminum contained in each
sample to the total aluminum in Examples 1-4

| | impurity- | first filtrate | copper- | cobalt- |
|---|---|---|---|---|
| | containing | (aluminum | containing | containing |
| items | battery powder | recovery rate) | slag | acid solution |
| Example 1 | 7.1% | 85.7% | 1.3% | 6.0% |
| Example 2 | 5.0% | 89.8% | 1.9% | 3.2% |
| Example 3 | 2.8% | 94.5% | 0.6% | 2.1% |
| Example 4 | 3.9% | 92.3% | 0.9% | 2.8% |

TABLE 2
The ratio of the cobalt contained in each
sample to the total cobalt in Examples 1-4

| | impurity- | | copper- | cobalt- |
|---|---|---|---|---|
| | containing | first | containing | containing |
| items | battery powder | filtrate | slag | acid solution |
| Example 1 | 91.9% | 1.5% | 6.1% | 0.5% |
| Example 2 | 92.7% | 2.8% | 3.8% | 0.7% |
| Example 3 | 94.9% | 2.5% | 2.4% | 0.2% |
| Example 4 | 93.8% | 0.3% | 3.6% | 0.4% |

TABLE 3
Specific surface area and particle size of the aluminium-doped
needlelike tricobalt tetroxide prepared in Examples 1-4

| items | specific surface area (m²/g) | Dₘₐₓ (μm) | Dₘᵢₙ (μm) |
|---|---|---|---|
| Example 1 | 3.47 | 15.6 | 0.14 |
| Example 2 | 3.53 | 15.3 | 0.13 |
| Example 3 | 3.45 | 16.1 | 0.15 |
| Example 4 | 3.41 | 15.9 | 0.14 |

As can be seen from tables 1-3, in Examples 1-4, the aluminum contained in the first filtrate accounted for 85.7%, 89.8%, 94.5% and 92.3% of the total aluminum (the total aluminum was the sum of aluminum in the impurity-containing battery powder, the first filtrate, the copper-containing slag and the cobalt-containing acid solution); the aluminum contained in the impurity-containing battery powder accounted for 7.1%, 5.0%, 2.8% and 3.9% of the total aluminum, while the cobalt contained in the impurity-containing battery powder accounted for 91.9%, 92.7%, 94.9% and 93.8% of the total cobalt. It was showed that the use of aminoacetic acid in combination of the addition of alkali was effective in selectively removing aluminum, as most of aluminum in the impurity-containing battery powder was removed while cobalt was retained in the copper-containing slag, and aluminum was effectively recovered in a green way. In addition, as shown in Table 3, the aluminium-doped needlelike tricobalt tetroxide prepared in Examples 1˜4 showed relatively closed data in terms of their specific surface area, Dₘₐₓ and Dₘᵢₙ, indicating that their morphologies are highly consistent.

The examples of the present disclosure have been described above in detail in conjunction with the drawings, but this invention is not limited thereto. Their variations can be made by those of ordinary skill in the art within the scope of their knowledge and without departing from the spirit of the present invention. In addition, the features of these examples can be combined with each other in the case of no conflict.

1. A method for preparing aluminium-doped needlelike tricobalt tetroxide, comprising the following steps:
(1) mixing waste battery powder with an amino acid solution, adjusting pH to alkalinity, and performing solid-liquid separation, to obtain aluminum-removed battery powder and a first filtrate;
(2) mixing the aluminum-removed battery powder with an acid solution, and performing solid-liquid separation, to obtain a cobalt-containing acid solution and a copper-containing slag; and
(3) adding a template agent into the cobalt-containing acid solution dropwise, adjusting pH with an alkali, performing centrifugation and thermal treatment, to obtain the aluminium-doped needlelike tricobalt tetroxide.

2. The method according to claim 1, wherein in step (1), the waste battery powder is prepared by disassembling a waste lithium cobaltate traction battery pack into cells, discharging the cells, performing thermal decomposition on the cells in a rotary kiln, cooling, shredding, and screening.

3. The method according to claim 1, wherein in step (1), the amino acid solution is a solution of aminoacetic acid which has a concentration of 5 wt %-20 wt %; and the solid-liquid ratio of the waste battery powder to the amino acid solution is 10-60 g/L.

4. The method according to claim 1, wherein in step (1) and in step (3), the alkali used in the pH adjustment is one of lithium hydroxide, sodium hydroxide and potassium hydroxide.

5. The method according to claim 1, wherein in step (3), the template agent is added into the cobalt-containing acid solution dropwise in a molar quantity 1-5 times that of cobalt in the cobalt-containing acid solution.

6. The method according to claim 1, in step (3), further comprising: adding the first filtrate obtained in step (1) at an amount of 0.001-0.01 of the volume of the cobalt-containing acid solution during adding the template agent into the cobalt-containing acid solution dropwise.

7. The method according to claim 1, wherein in step (3), the template agent is one of aminosalicylic acid and hydroxyl-containing benzoic acid.

8. The method according to claim 1, wherein in step (3), the thermal treatment is carried out at a temperature of 550-750° C. for a duration of 1-6 h under an atmosphere of air.

9. Aluminium-doped needlelike tricobalt tetroxide, prepared by the method according to claim 1, which has a chemical formula of Co₃O₄@C/Al₂O₃ and a specific surface area of 3.4-3.6 m²/g.

10. Use of the aluminium-doped needlelike tricobalt tetroxide according to claim 9 in the preparation of a catalyst, a cathode material or a capacitor.

11. Aluminium-doped needlelike tricobalt tetroxide, prepared by the method according to claim 2, which has a chemical formula of Co₃O₄@C/Al₂O₃ and a specific surface area of 3.4-3.6 m²/g.

12. Aluminium-doped needlelike tricobalt tetroxide, prepared by the method according to claim 3, which has a chemical formula of Co₃O₄@C/Al₂O₃ and a specific surface area of 3.4-3.6 m²/g.

13. Aluminium-doped needlelike tricobalt tetroxide, prepared by the method according to claim 4, which has a chemical formula of Co₃O₄@C/Al₂O₃ and a specific surface area of 3.4-3.6 m²/g.

14. Aluminium-doped needlelike tricobalt tetroxide, prepared by the method according to claim 5, which has a chemical formula of Co₃O₄@C/Al₂O₃ and a specific surface area of 3.4-3.6 m²/g.

15. Aluminium-doped needlelike tricobalt tetroxide, prepared by the method according to claim 6, which has a chemical formula of Co₃O₄@C/Al₂O₃ and a specific surface area of 3.4-3.6 m²/g.

16. Aluminium-doped needlelike tricobalt tetroxide, prepared by the method according to claim 7, which has a chemical formula of Co₃O₄@C/Al₂O₃ and a specific surface area of 3.4-3.6 m²/g.

17. Aluminium-doped needlelike tricobalt tetroxide, prepared by the method according to claim 8, which has a chemical formula of Co₃O₄@C/Al₂O₃ and a specific surface area of 3.4-3.6 m²/g.

18. Use of the aluminium-doped needlelike tricobalt tetroxide according to claim 11 in the preparation of a catalyst, a cathode material or a capacitor.

19. Use of the aluminium-doped needlelike tricobalt tetroxide according to claim 12 in the preparation of a catalyst, a cathode material or a capacitor.

20. Use of the aluminium-doped needlelike tricobalt tetroxide according to claim 13 in the preparation of a catalyst, a cathode material or a capacitor.
